(19) United States
(12) Patent Application Publication
(10) Pub. No.: US 2005/0232345 A1
(43) Pub. Date: Oct. 20, 2005

(54) Histograms, trends and spectrums of random and deterministic jitter

(76) Inventors: Benjamin A. Ward, Portland, OR (US); Kan Tan, Beaverton, OR (US); Mark L. Guenther, Portland, OR (US)

Correspondence Address: Thomas F. Lenihan;TEKTRONIX, INC., M/S 50-LAW, P.O. Box 500, Beaverton, OR, 97077-0001, US

(21) Appl. No.: 11/098,883

(22) Filed: Apr. 4, 2005

Related U.S. Application Data
(60) Provisional application No. 60/562,728, filed on Apr. 16, 2004.

(51) Int. Cl. H04Q 1/20

(52) U.S. Cl. 375/224

(57) ABSTRACT

For a jitter measurement product histograms, trends and spectrums of random and deterministic jitter components are provided on a jitter component basis rather than just on overall jitter. At each stage of the jitter separation histograms, time trends (measurement vs. time), cycle trends (measurement vs. cycle or UI) or spectrums may be provided. Additionally the spectrum for a periodic jitter component may be further separated into sub-spectrums representing correlated sub-sets of the periodic jitter component. Conversion of each sub-spectrum into the time domain provides a characteristic signal that may identify one source of the periodic jitter. From the various plots the contribution of a particular jitter component or a particular combination of jitter components to an eye opening and system performance may be obtained.

### BACKGROUND OF THE INVENTION

The present invention relates to data signal timing measurements, and more particularly to histograms, trends and spectrums of random and deterministic jitter.

“Jitter” is a well-known term of art used to define the deviation from an ideal timing of an event in an electrical signal. Jitter in digital signals, if large enough, can render the digital signals unusable as the values of data units within the signal become ambiguous. For example excessive jitter may increase the bit error rate (BER) of a communication signal by causing incorrect decisions on a data bit stream. In digital systems jitter may violate timing margins, causing circuits to behave improperly. As a result accurate jitter measurements are necessary to determine the robustness of a system and how close it is to failing.

Instruments that make jitter measurements in serial data signals, clocks and other signals have been available for many years. More recently there have been instruments that provide the ability to separate the jitter into root components. The decomposition of jitter is labeled Random and Deterministic Jitter Analysis (RJ/DJ for short). The jitter components include random jitter (RJ) that is unbounded and uncorrelated and deterministic jitter (DJ) that is caused by one or more systematic causes. The most common components of DJ are data dependent jitter (DDJ) or inter-symbol interference (ISI) that is jitter induced by the serial data pattern itself; duty cycle distortion (DCD) that are jitter differences solely dependent on the polarity of the signal transitions or edges (a further separation of DDJ); periodic jitter (PJ) that is regular systematic jitter uncorrelated with data; and bounded uncorrelated jitter (BUJ) that is jitter caused by other than the data on the signal (excluding PJ), such as crosstalk.

RJ/DJ separation analysis is applied to a time interval error (TIE) measurement. The serial data waveform is processed to find edge locations that may be expressed as data edge times. The data edge times are used in a clock recovery circuit to obtain ideal edge times that are subtracted from the data edge times to produce time interval errors. As described in U.S. Pat. No. 6,832,172 the RJ/DJ separation may be performed by applying a spectrum analysis approach to the TIE measurements. This technique requires a cyclically-repeating serial data pattern. “Missing” jitter may be interpolated at non-transition unit interval (UI) boundaries. The spectrum of the complete TIE data reveals jitter components that may be separated. Deterministic jitter appears as taller spikes in the spectrum. When the spectral spike's frequency is the fundamental or harmonic of a pattern repeat frequency, the jitter belongs to DDJ or DCD. If the spike falls at another frequency, it is PJ. The remaining spectral energy is RJ. Inverse discrete Fourier transforms (iDFTs) of the different spectral components allow peak-to-peak measurements to be made on each component. RJ is assumed to be Gaussian and its distribution is determined from the residual RJ spectral power.

Another technique described in U.S. Patent Application Publication No. 2004/0136450 A1 does not require a cyclically-repeating serial data pattern. DDJ and DCD are calculated from the TIE measurements by sorting each measurement into one of 2^{N} pattern groups based on the N bits preceding the edge in question. The average of each of these sorted groups constitute the DDJ for that pattern. Rising and falling edges may be collected separately to determine DCD. The averaged jitter for each pattern group may be subtracted from all the respective TIE measurements that are sorted into that group. This is repeated for each of the 2^{N} patterns. This same result may be calculated by creating a complete DDJ/DCD vs. cycle vector (array) based on the local pattern of the original signal and subtracting it from the original TIE measurements or vector. The net effect is the same. Once DDJ and DCD are determined, they are removed from the original TIE measurements, leaving an error signal with RJ and PJ. Separating PJ from RJ is accomplished in a manner identical to the RJ/PJ paths indicated in the above-described spectral method, or some other method of periodic signal estimation.

The jitter measurement results typically give RJ as an RMS value and DJ with all its sub-components as peak-to-peak values. A bathtub curve for total jitter (see FIG. 11 of the above-mentioned U.S. Pat. No. 6,832,172), or eye pattern closure, at a given BER is derived from the RJ/DJ results. There may be separate histogram views of total jitter, the combined RJ/PJ and the remaining rising edge and/or falling edge DDJ. FIG. 1A shows a typical time trend for total jitter, while FIGS. 1B and 1C show the corresponding histogram and spectrum respectively. However there are no current instruments that provide a complete view for each of the individual jitter components.

What is desired is an instrument that provides histograms, trends and spectrum plots for all random and deterministic components of jitter.

### BRIEF SUMMARY OF THE INVENTION

Accordingly the present invention provides a method of displaying histograms, trends and spectrum plots for all random and deterministic components of jitter. For a jitter measurement instrument histograms, trends and spectrums of random and deterministic jitter components are provided on a jitter component basis rather than just on overall jitter. At each stage of the jitter separation process histograms, time trends (measurement vs. time), cycle trends (measurement vs. cycle or UI) or spectrums may be provided. Additionally the spectrum for a periodic jitter component may be further separated into sub-spectrums representing correlated sub-sets of the periodic jitter component. Conversion of each sub-spectrum into the time domain provides a characteristic signal that may identify one source of the periodic jitter.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a graphic view illustrating (A) trends, (B) histograms and (C) spectrum plots for total jitter according to the present invention.

FIG. 2 is a block diagram view for displaying histograms, trends and spectrum plots for all random and deterministic components of jitter as applied to a spectral separation approach according to the present invention.

FIG. 3 is a graphic view illustrating (A) trends, (B) histograms and (C) spectrum plots for random jitter according to the present invention.

FIG. 4 is a graphic view illustrating (A) trends, (B) histograms and (C) spectrum plots for data dependent jitter according to the present invention.

FIG. 5 is a graphic view illustrating (A) trends, (B) histograms and (C) spectrum plots for duty cycle distortion jitter according to the present invention.

FIG. 6 is a graphic view illustrating (A) trends, (B) histograms and (C) spectrum plots for periodic jitter according to the present invention.

FIG. 7 is a graphic view illustrating (A) trends, (B) histograms and (C) spectrum plots for a component of periodic jitter according to the present invention.

FIG. 8 is a block diagram view for displaying histograms, trends and spectrum plots for all random and deterministic components of jitter as applied to an arbitrary pattern matching approach according to the present invention.

### DETAILED DESCRIPTION OF THE INVENTION

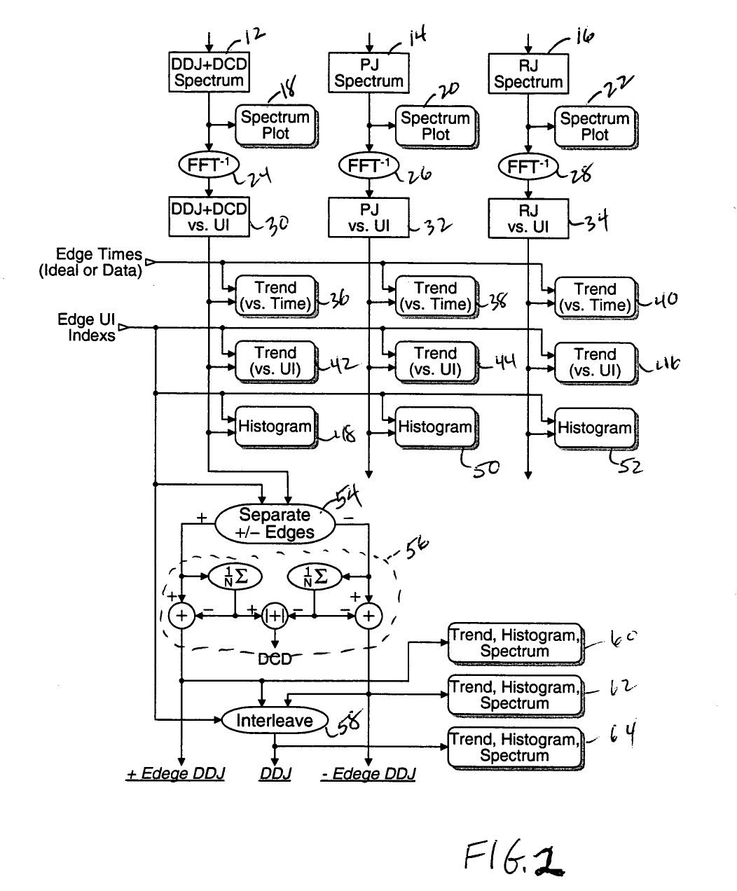

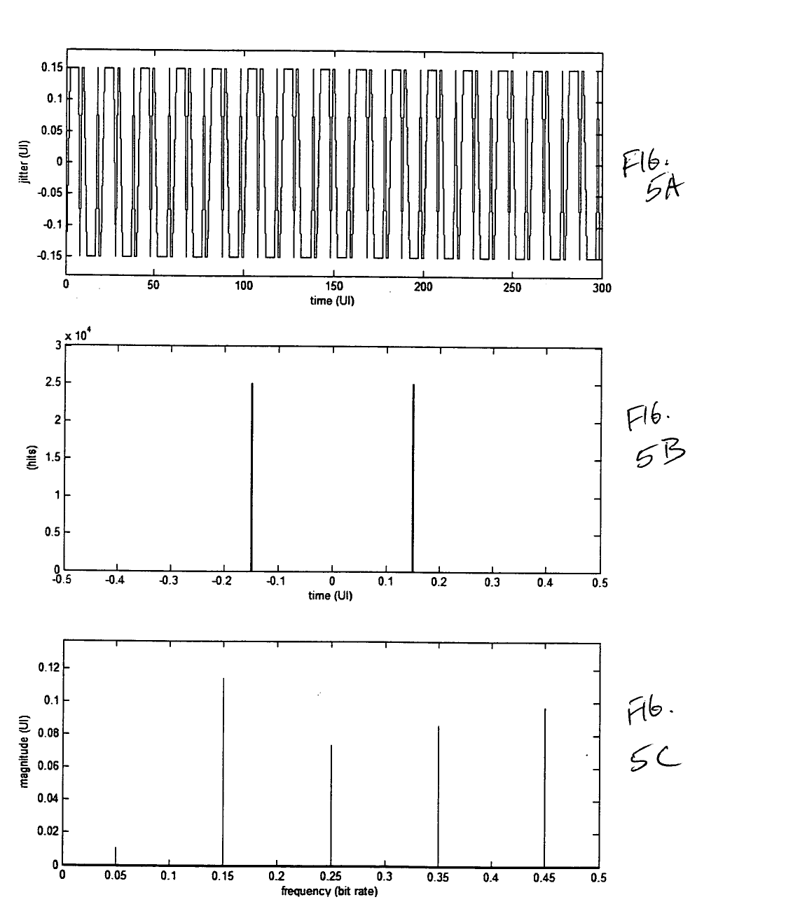

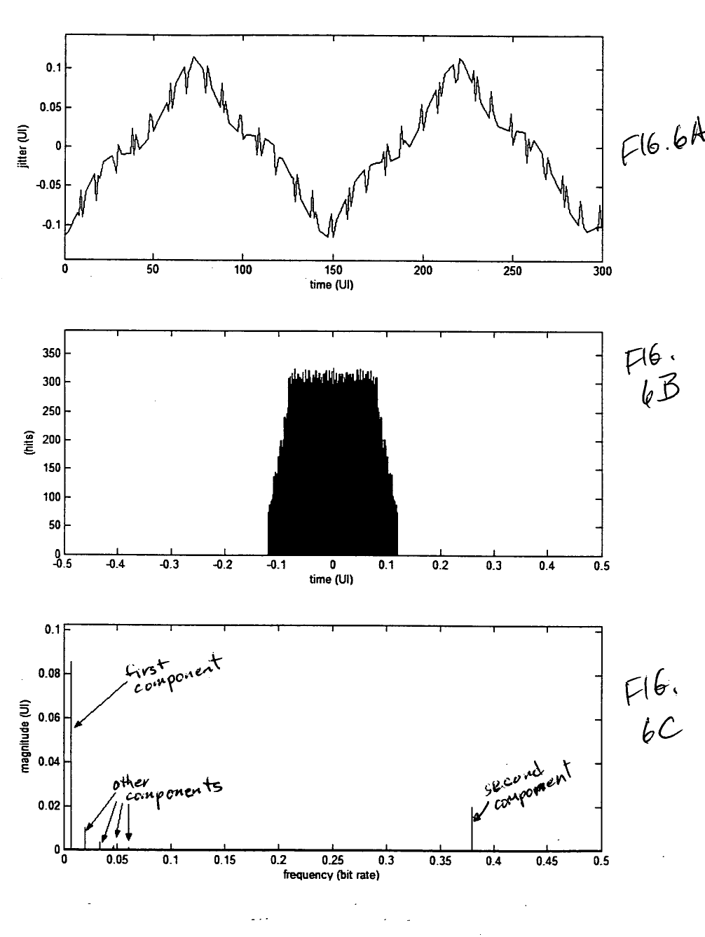

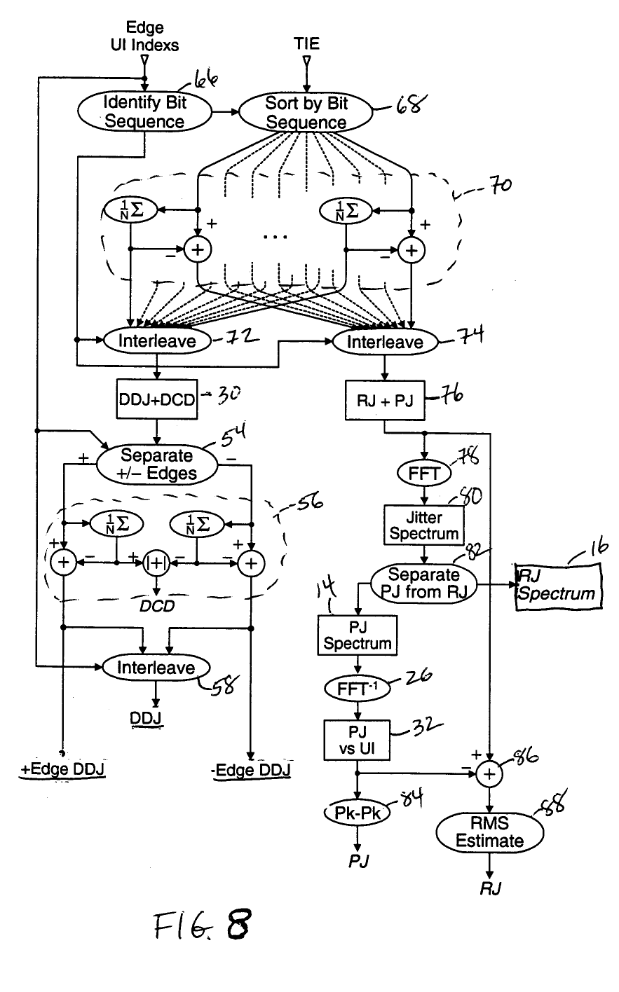

Referring now to FIG. 2 using the spectrum approach as disclosed in the above-mentioned U.S. Pat. No. 6,832,172 (FIGS. 5 and 8) the jitter is separated spectrally into DDJ+DCD (12), PJ (14) and RJ (16). The prior art as exemplified by the above-mentioned U.S. Pat. No. 6,832,172 (FIG. 6) only provides a spectral display of the total jitter. However the present invention provides a spectral display (18, 20, 22) for each of the three separated jitter components. Each of the spectral components (12, 14, 16) is converted to the time domain by an inverse DFT function (24, 26, 28) to provide jitter versus unit interval data (30, 32, 34). From the jitter versus unit interval data, trend versus time plots (36, 38, 40) using edge times (ideal or measured), trend versus UI plots (42, 44, 46) using edge unit interval indices and histogram plots (48, 50, 52) may be displayed.

The PJ spectrum plot may be analyzed further to differentiate PJ components so that, by providing a time domain version of each PJ component, a characteristic of each component may be shown to help identify the source of the particular PJ component. For example a 60 Hz component may be an indication that jitter is being introduced by a power supply, while a high frequency component may be an indication that jitter is being introduced by an outside, competing communication system.

The time domain DDJ+DCD may also be separated by rising (+) and falling (−) edges (54) using the edge unit interval indices. The +Edge and −Edge data are processed (56) to separate the DCD component and provide the +Edge DDJ and −Edge DDJ, and are interleaved (58) using the edge unit interval indices to produce total DDJ. Trend, histogram and spectrum (60, 62, 64) may be displayed for each of the DDJ components, the spectrum portion being the result of converting the time domain data back to the frequency domain.

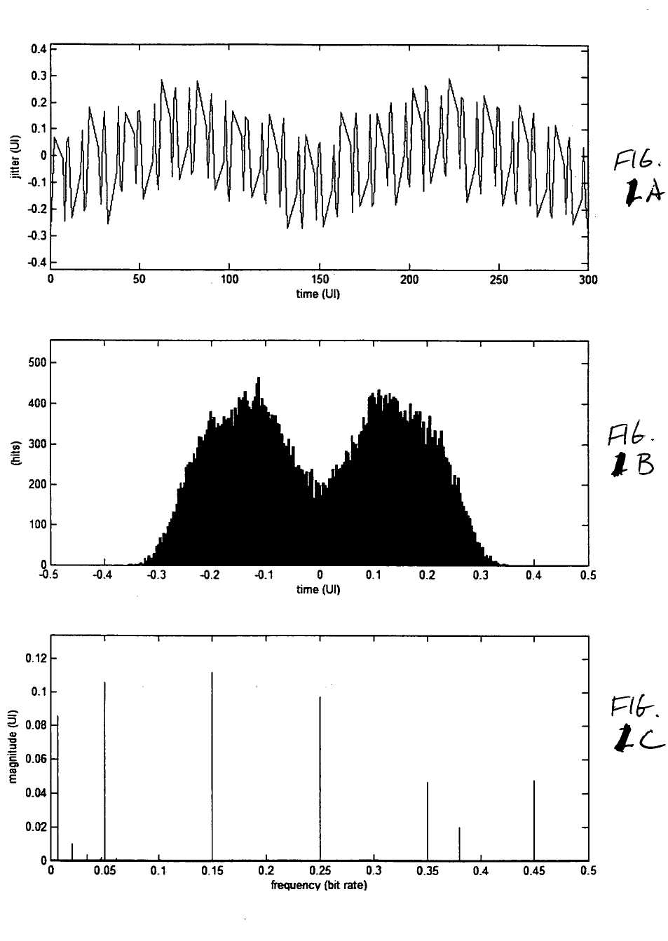

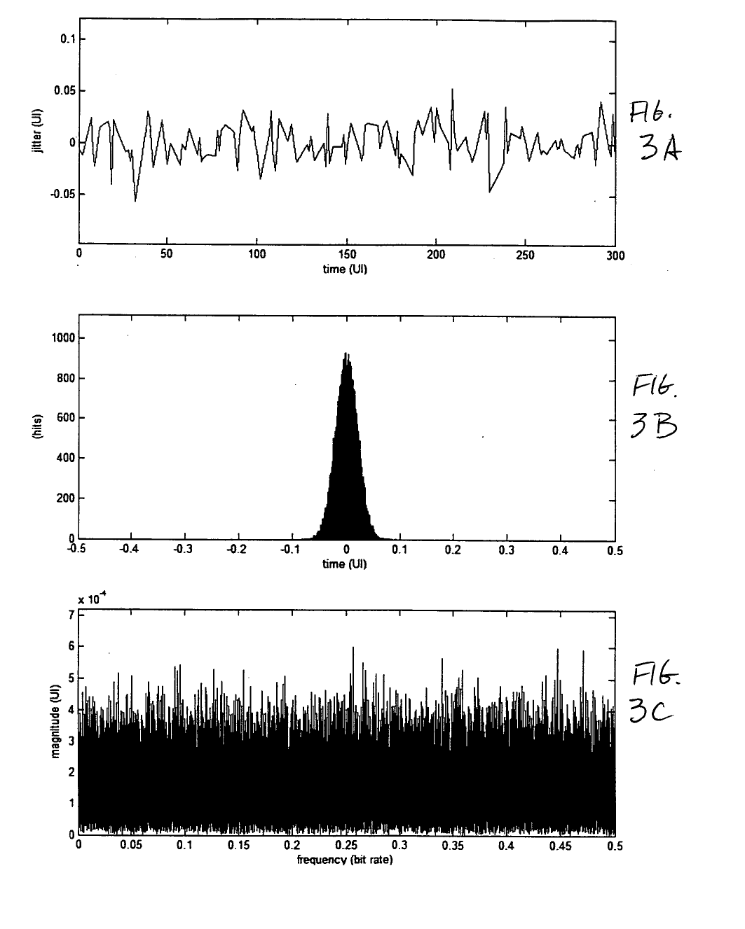

FIGS. 3-7, described below, show plots of jitter components obtained by applying decomposition algorithms to the total jitter shown in FIG. 1. These drawing figures provide an illustrative example of the present invention.

FIG. 3A shows the time trend (40) for random jitter in terms of unit intervals. The corresponding histogram (52) of FIG. 3B shows the expected Gaussian distribution. Likewise the spectrum (22) of FIG. 3C shows no significant peaks, but rather a smearing across the frequency spectrum.

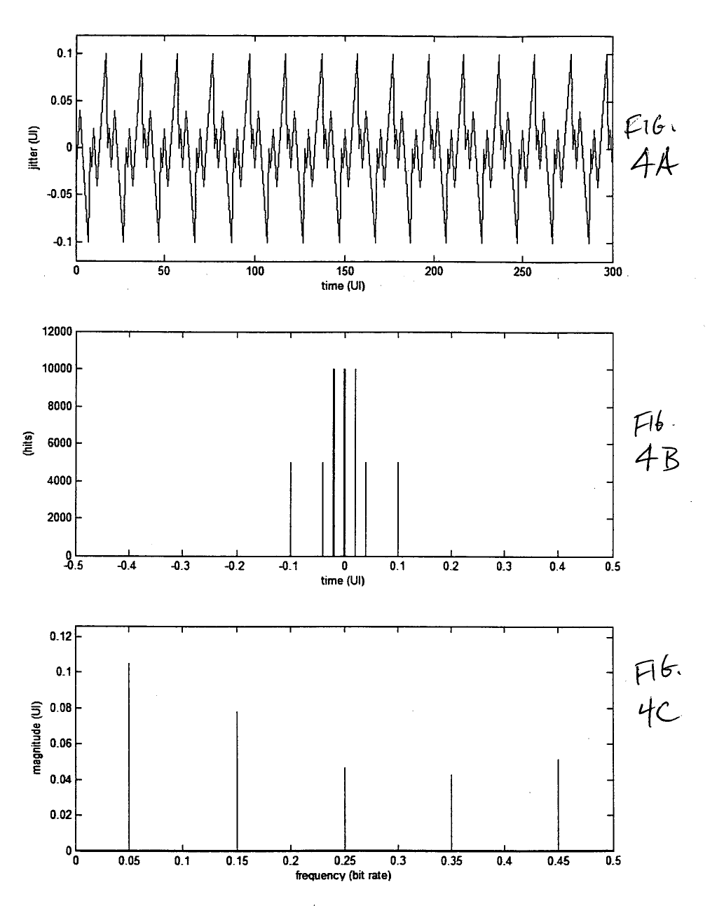

FIG. 4A shows the time trend (64) for data dependent jitter for both negative and positive edges. The underlying data pattern for this example is 11000001010011111010—at a first level for two UIs, at a second level for five UIs, at the first level for one UI, etc. The corresponding histogram and spectrum (64) are shown in FIGS. 4B and 4C. Note the spectrum shows peaks at regular frequency intervals related to the data pattern repeat frequency, and the histogram shows a discrete pattern.

FIG. 5A shows the time trend for duty cycle distortion jitter. DCD jitter often has a histogram composed of two distinct peaks (“dual-Dirac”), as shown in FIG. 5B. The spectrum is shown in FIG. 5C.

FIG. 6A shows the time trend (38) for periodic jitter. The plot shows a jitter signal that is composed primarily of triangular and sinusoidal modulation. FIGS. 6B and 6C show the corresponding histogram (50) and spectrum (20). In the spectrum plot there is a first component that may be selected by a user or by an automated algorithm. A set of other components in the spectrum may be grouped with the first component, either manually by a user or by the same or a different automated algorithm. One basis for establishing groups is that of a harmonic relationship, meaning that the frequencies of the components of the group are integrally divisible by a common fundamental frequency. The fundamental frequency may or may not correspond to one of the components visible in the spectrum. Other groupings are possible. A second component corresponding to the sinusoidal modulation is not grouped with the first component and the other components that correspond to the triangular modulation. In the example shown it is excluded from the first grouping because it is not harmonically related to those components. As indicated above an inverse DFT is then performed on the selected group of components.

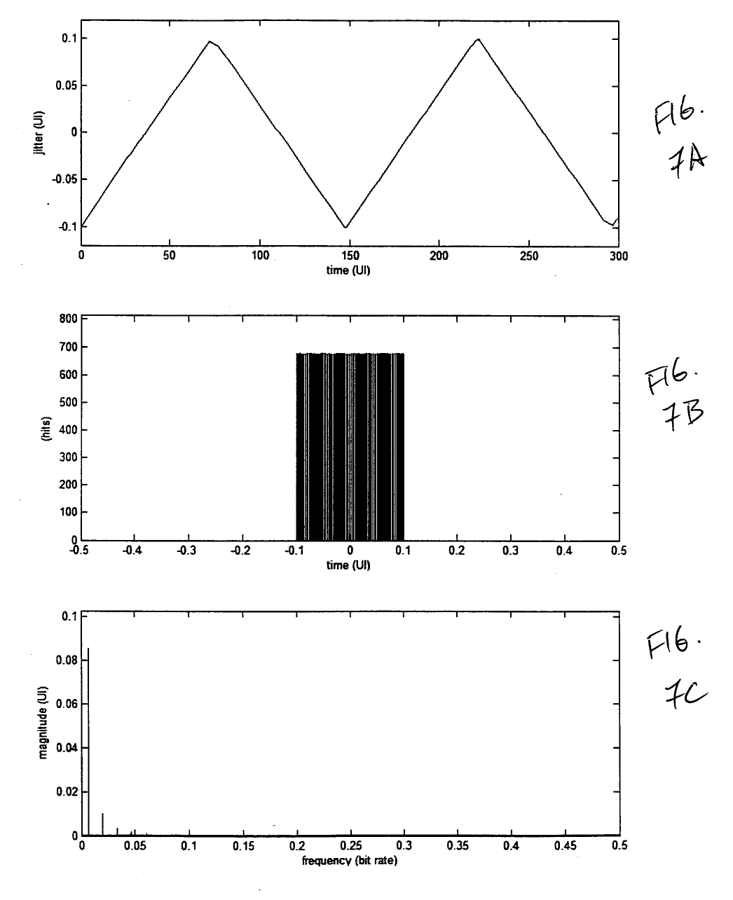

FIG. 7C shows the spectrum for the separated signal having the fundamental frequency and the correlating harmonic frequencies—compare with FIG. 6C. FIG. 7A shows the time trend for the separated signal of the periodic jitter as a result of the inverse DFT. The triangular modulation becomes readily apparent. FIG. 7B shows the corresponding histogram.

Referring now to FIG. 8 the starting point is the TIE measurement. From edge UI indices a bit sequence is identified (66), and the TIE measurements are sorted (68) by the bit sequence. The TIE measurements are grouped (70) into 2^{N} pattern groups based on the N bits preceding each edge. The groupings are interleaved (72, 74) to provide DDJ+DCD (30) as the average of the sorted groups and RJ+PJ (76) as the difference between the total jitter and the DDJ+DCD. The DDJ+DCD are processed as in FIG. 2 to produce DDJ, +Edge DDJ and −Edge DDJ. RJ+PJ may be separated using a spectrum method by converting to the frequency domain (78) to produce a jitter spectrum (80) and then separating (82) the PJ from the RJ to produce the respective spectrums (14, 16). The PJ spectrum may then be processed as in FIG. 2. Peak-to-peak values (84) may be obtained from the time domain PJ data (32). Also the RJ value may be obtained by subtracting (86) the PJ time domain data from the RJ+PJ data and then obtaining the resultant RMS estimate (88). All of the jitter components may be independently plotted as trend versus time, trend versus UI, spectrum plot (after conversion to the frequency domain) or histogram, as in FIG. 2. All possible plot points are not shown in FIG. 8, as most are already shown in FIG. 2.

Looking at total jitter, eye opening and bathtub curve from the sub-sets of the jitter components gives the user clues as to which jitter sources contribute more to the eye opening or total jitter than other jitter sources do. The sub-sets also give the user an estimate of the system performance that could be achieved, in terms of eye opening versus bit error rate to meet design specifications and in terms of qualitative and quantitative improvements, if some of the jitter sources are removed. Then the user may choose the right jitter source to work on in order to meet system performance specifications.

Thus the present invention provides the ability to produce trend, spectrum and histogram plots for each component of jitter.

1. A method of providing trend, spectrum or histogram plots for jitter in a digital signal comprising the steps of:
measuring a total jitter for the digital signal;
separating the total jitter into jitter components; and
providing plots selected from the group consisting of trend, spectrum and histogram for each jitter component in addition to corresponding plots for the total jitter.

2. The method as recited in claim 1 further comprising the steps of:
further separating spectral components of a frequency domain representation for a periodic jitter component into subsets, each subset representing a source of periodic jitter; and
interpreting the spectral components for each subset to aid determination of the source of the periodic jitter represented by the subset.

3. The method as recited in claim 2 wherein the further separating step comprises the steps of:
identifying a first frequency from the spectral components; and
associating with the first frequency in one of the subsets other frequencies from the spectral components that are integrally divisible by a common frequency related to the first frequency.

4. The method as recited in claims 2 or 3 wherein the interpreting step comprises the step of converting each subset to the time domain to provide a time trend plot for each source of the periodic jitter to aid in identifying the source.

5. The method as recited in claim 1 wherein the separating step comprises the steps of:
separating the total jitter as represented by time interval error measurements of the digital signal into random jitter and deterministic jitter;
further separating the deterministic jitter into signal dependent jitter and periodic jitter; and
yet further separating the signal dependent jitter into data dependent jitter and duty cycle distortion, the random jitter, deterministic jitter, periodic jitter, data dependent jitter and duty cycle distortion being the jitter components.

6. The method as recited in claim 5 wherein the providing step comprises the steps of:
plotting selectively frequency domain representations for the total jitter and each of the jitter components;
plotting selectively time domain representations for the total jitter and each of the jitter components; and
plotting selectively from the time domain representations histograms for the total jitter and each of the jitter components.

7. The method as recited in claim 1 further comprising the step of computing total jitter, eye opening and bathtub curves from each jitter component or from a selected combination of jitter components to give a user clues as to which jitter sources should be addressed to improve system performance in terms of eye opening versus bit error rate to meet design specifications and in terms of quantitative and qualitative improvements.
